(19) United States
(12) Patent Application Publication
(10) Pub. No.: US 2026/0012063 A1
(43) Pub. Date: Jan. 8, 2026

(54) COOLING SYSTEM FOR ROTARY ELECTRIC MACHINE

(71) Applicant: Hitachi Astemo, Ltd., Hitachinaka-shi, Ibaraki (JP)

(72) Inventors: Hideaki GOTO, Hitachinaka-shi, Ibaraki (JP); Takaki ITAYA, Hitachinaka-shi, Ibaraki (JP)

(73) Assignee: Hitachi Astemo, Ltd., Hitachinaka-shi, Ibaraki (JP)

(21) Appl. No.: 18/992,853

(22) PCT Filed: Jul. 13, 2022
(86) PCT No.: PCT/JP2022/027547

§ 371 Date: Jan. 9, 2025

(51) Int. Cl. H02K 9/193; B60K 11/02

(52) U.S. Cl. CPC H02K 9/193; B60K 11/02

(57) ABSTRACT

An object of the present invention is to provide a cooling system for a rotary electric machine in which the flow rate ratio between a coolant supplied to a stator and the coolant supplied to a rotor can be changed and the cooling effect of the rotary electric machine can be improved. The cooling system 1 for the rotary electric machine 2 of this embodiment includes the coolant flow path 7 supplying the coolant, the switching mechanism 3 switching the mode of the coolant flow path 7, and the pump 4 pumping the coolant to the coolant flow path 7. The coolant flow path 7 has the first coolant flow path section 71 supplying the coolant to the core 21A of the stator 21, and the second coolant flow path section 72 supplying the coolant to the rotor 22. The switching mechanism 3 is configured to achieve the first mode in which the coolant is supplied to the first coolant flow path section 71 and the coolant is not supplied to the second coolant flow path section 72, and the second mode in which the downstream of the first coolant flow path section 71 and the upstream of the second coolant flow path section 72 are made to communicate with each other.

### TECHNICAL FIELD

This invention relates to a cooling system for a rotary electric machine.

### BACKGROUND ART

Patent Literature 1 describes a cooling system for a rotary electric machine including coolant flow paths (a first coolant flow path and a sixth coolant flow path) supplying a coolant to a first coil end section and a second coil end section of the rotary electric machine and a coolant flow path (a fifth coolant flow path) supplying the coolant to a magnet of the rotary electric machine (paragraphs 0027, 0031, and 0032). The first coil end section and the second coil end section are provided to a stator, and the coolant flow paths (the first coolant flow path and the sixth coolant flow path) configure coolant flow paths which supply the coolant to the stator. The magnet is provided in a rotor, and the coolant flow path (the fifth coolant flow path) configures a coolant flow path which supplies the coolant to the rotor. The fifth coolant flow path is provided branching from the first coolant flow path, and is configured to make flow part of the coolant flowing in the first coolant flow path toward the magnet of the rotor (the paragraph 0031).

### CITATION LIST

### Patent Literature

Patent Literature 1: Japanese Unexamined Patent Application Publication No. 2019-161898

### SUMMARY OF INVENTION

### Technical Problem

In the cooling system for the rotary electric machine of Patent Literature 1, the connection state of the first coolant flow path and the fifth coolant flow path is not changed. Due to this, the flow rate of the coolant supplied to the stator and the flow rate of the coolant supplied to the rotor are changed according to the flow rate of the coolant flowing in the first coolant flow path while maintaining the constant flow rate.

An object of the present invention is to provide a cooling system for a rotary electric machine in which the flow rate ratio between a coolant supplied to a stator and the coolant supplied to a rotor can be changed and the cooling effect of the rotary electric machine can be improved.

### Solution to Problem

In order to achieve the above object, in the present invention, a cooling system for a rotary electric machine including a stator and a rotor, includes: a coolant flow path supplying a coolant; a switching mechanism switching the mode of the coolant flow path; and a pump pumping the coolant to the coolant flow path. The coolant flow path has a first coolant flow path section supplying the coolant to a core of the stator, and a second coolant flow path section supplying the coolant to the rotor, and the switching mechanism is configured to achieve a first mode in which the coolant is supplied to the first coolant flow path section and the coolant is not supplied to the second coolant flow path section, and a second mode in which the downstream of the first coolant flow path section and the upstream of the second coolant flow path section are made to communicate with each other.

### Advantageous Effects of Invention

According to the present invention, it is possible to change the flow rate ratio between a coolant supplied to a stator and the coolant supplied to a rotor, and to improve the cooling effect of the rotary electric machine.

Objects, configurations, and effects other than the above will be apparent from the description of the following embodiments.

### BRIEF DESCRIPTION OF DRAWINGS

FIG. 1 is a diagram illustrating an outline of the configuration of a first embodiment (embodiment 1) of a cooling system for a rotary electric machine of the present invention.

FIG. 2 is a schematic diagram illustrating a changing example (a first changing example: changing example 1) of the configuration of a pump of the cooling system for the rotary electric machine according to the first embodiment of the present invention.

FIG. 3 is a schematic diagram illustrating a changing example (a second changing example: changing example 2) of the driving source of the pump of the cooling system for the rotary electric machine according to the first embodiment of the present invention.

FIG. 4 is a schematic diagram illustrating a changing example (a third changing example: changing example 3) of the driving source of the pump of the cooling system for the rotary electric machine according to the first embodiment of the present invention.

FIGS. 5 are each an explanatory view illustrating the connection mode of a coolant flow path of the cooling system for the rotary electric machine of FIG. 1.

FIG. 6 is a diagram illustrating the relationship between the vehicle speed and the coolant supply amount in the cooling system for the rotary electric machine according to the present invention.

FIG. 7 is a schematic configuration diagram illustrating a changing example (a fourth changing example: changing example 4) of a switching mechanism of the cooling system for the rotary electric machine according to the first embodiment of the present invention.

FIG. 8 is a diagram illustrating the opened or closed state of a valve in each speed range of the cooling system for the rotary electric machine of FIG. 7.

FIG. 9 is a schematic configuration diagram illustrating a changing example (a fifth changing example: changing example 5) of the switching mechanism of the cooling system for the rotary electric machine according to the first embodiment of the present invention.

FIG. 10 is a diagram illustrating the relationship between the vehicle speed and the coolant supply amount for the case where the operation range of an electric pump is changed in the cooling system for the rotary electric machine according to the present invention.

### DESCRIPTION OF EMBODIMENTS

An e-Axle in which a motor, an inverter, and a gear are integrated has higher loss density with higher output density. To cope with the higher loss density, the cooling performance of a rotary electric machine by a cooling system having a direct oil cooling configuration is desired to be improved. In the oil cooling configuration, a pump pumping a coolant (a cooling oil) is required. As the pump, for example, a mechanical pump (a mechanical oil pump) and an electric pump (an electric oil pump) can be used. Note that since the discharge amount of the mechanical pump is changed according to the speed, when the mechanical pump is used, the coolant supply amount is required to be appropriately controlled in order to secure the cooling performance at each speed.

In the following embodiment, an example in which the mechanical pump is used will also be described. Since the discharge amount of the mechanical pump is reduced in the low speed range, the cooling performance of the rotary electric machine in the low speed range is lowered. To prevent the lowering of the cooling performance in the low speed range, the pump is required to be larger. In the embodiment in which the mechanical pump is used, the pump is prevented from being larger, by suppressing the lowering of the cooling performance of the rotary electric machine in the low speed range.

In addition, in the following embodiment, the loss torque in the middle speed range whose usage frequency is high in city area traveling is reduced, and the electric efficiency is improved.

Hereinafter, one embodiment of the present invention will be described with reference to the drawings.

### Embodiment 1

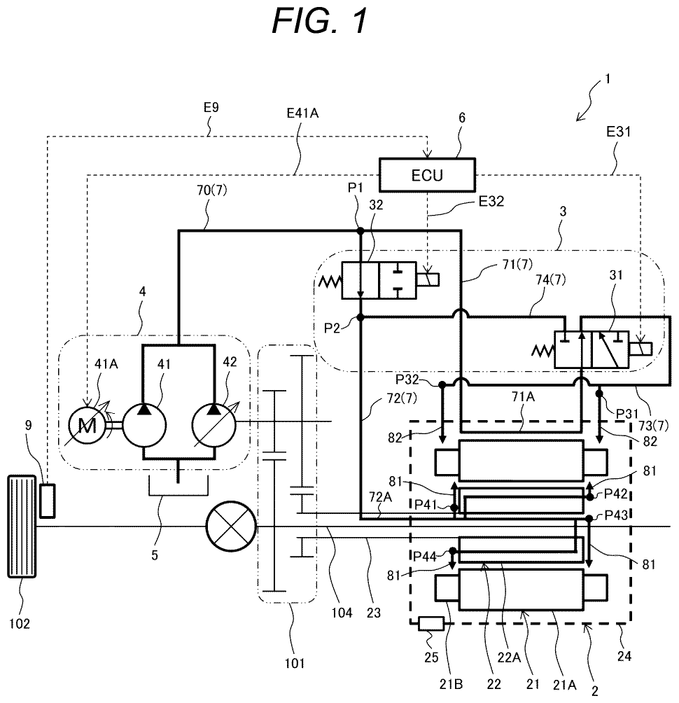

FIG. 1 is a diagram illustrating an outline of the configuration of a first embodiment (embodiment 1) of a cooling system 1 for a rotary electric machine 2 of the present invention.

The cooling system 1 of this embodiment is the cooling system 1 for the rotary electric machine 2 including a stator 21 and a rotor 22. The cooling system 1 includes the rotary electric machine 2, a pump 4 pumping a coolant (a cooling oil), a coolant flow path 7 in which the coolant (the cooling oil) flows, a switching mechanism 3 switching the connection states of respective coolant flow path sections 71, 72, 73, and 74 configured in the coolant flow path 7, a coolant reserving section (an oil pan) 5 reserving the coolant, a vehicle speed sensor 9 detecting a vehicle speed, and an electronic control unit (an ECU) 6. As the coolant of this embodiment, an oil is used, and the coolant may be called the cooling oil for description.

The rotary electric machine 2 includes the stator 21, the rotor 22, a housing 24 accommodating the stator 21 and the rotor 22, and a discharge port 25 for the coolant (the cooling oil). The stator 21 includes a core (stator core) 21A and a coil, and in FIG. 1, a coil end 21B of the coil is illustrated. The rotor 22 includes a core (rotor core) 22A, and is fixed to an output shaft 23. The output shaft 23 can also be assumed as part of the rotor 22. The housing 24 is a vessel for reserving the coolant, and is provided with the discharge port 25 from which the coolant is discharged.

The pump 4 is a part pumping the coolant to the coolant flow path 7, and in this embodiment, an example in which an electric pump 41 driven by an electric motor 41A and a mechanical pump 42 are used together is illustrated. The discharge amount of the electric pump 41 is controlled by the electronic control unit 6 according to the vehicle speed detected by the vehicle speed sensor 9. To receive a vehicle speed signal from the vehicle speed sensor 9, the electronic control unit (ECU) 6 is connected with the vehicle speed sensor 9 by a signal line E9. In addition, to control the electric pump 41, the electronic control unit (ECU) 6 is connected with the electric motor 41A by a signal line E41A. As the mechanical pump 42, a variable displacement pump or a fixed displacement pump is used. Since the discharge amount of the mechanical pump 42 is changed according to the vehicle speed, the discharge amount of the electric pump 41 is controlled by the electronic control unit 6 according to the discharge amount of the mechanical pump 42.

Since the mechanical pump 42 sucks the coolant from the rotary electric machine 2 side at the time of the backward movement (reversal) of the vehicle, a check valve, not illustrated, should be provided on the motor side in order for the mechanical pump 42 not to suck the coolant from the rotary electric machine 2 side at the time of the reversal, thereby sucking up the coolant from the coolant reserving section (the oil pan) 5 through a bypass path, not illustrated. In this case, the check valve should be provided in the mechanical pump 42 or between the mechanical pump 42 and the first coolant flow path section 71. In addition, the bypass path should be provided between the coolant reserving section (the oil pan) 5 and the first coolant flow path section 71 such that the coolant bypasses the mechanical pump 42 at the time of the backward movement of the vehicle. Note that to the bypass path, the check valve should be provided in order for the coolant not to leak at the time of the forward movement of the vehicle.

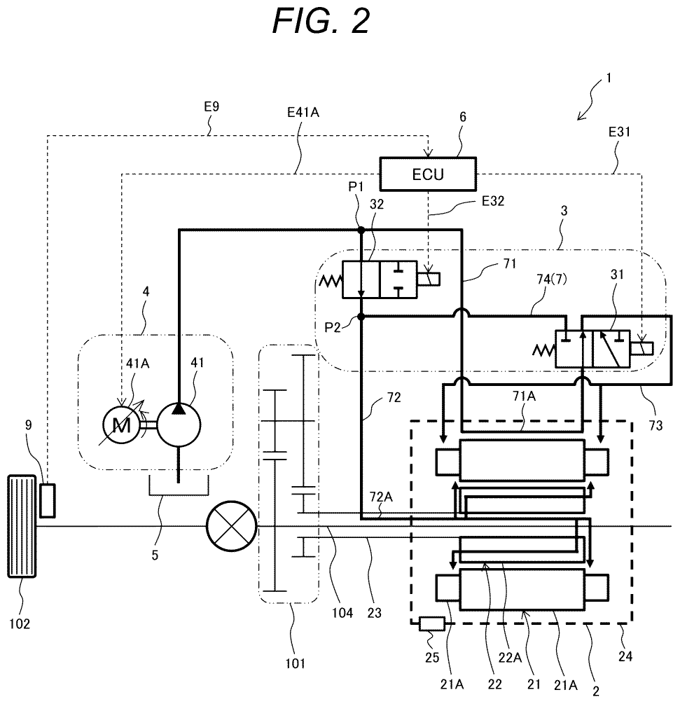

The pump 4 may be configured by using one of the electric pump 41 and the mechanical pump 42. FIG. 2 is a schematic diagram illustrating a changing example (a first changing example: changing example 1) of the configuration of the pump 4 of the cooling system 1 for the rotary electric machine 2 according to the first embodiment of the present invention. In FIG. 2, an example in which the pump 4 is configured by using the electric pump 41 without using the mechanical pump 42 is illustrated. The discharge amount of the electric pump 41 is controlled according to the vehicle speed so as to satisfy the cooling performance.

In this embodiment, the mechanical pump 42 secures a motive power from the shaft (speed reduction gear shaft) of a speed reduction gear 101 provided between the rotary electric machine 2 and a drive shaft 104.

That is, in this embodiment, the pump 4 includes the mechanical pump 42 and the electric pump 41, and the mechanical pump 42 secures the motive power from the shaft of the speed reduction gear 101 provided between the rotary electric machine 2 and the drive shaft 104.

However, the motive power of the mechanical pump 42 is not necessarily secured from the shaft (speed reduction gear shaft) of the speed reduction gear 101, and can also be secured from other portions.

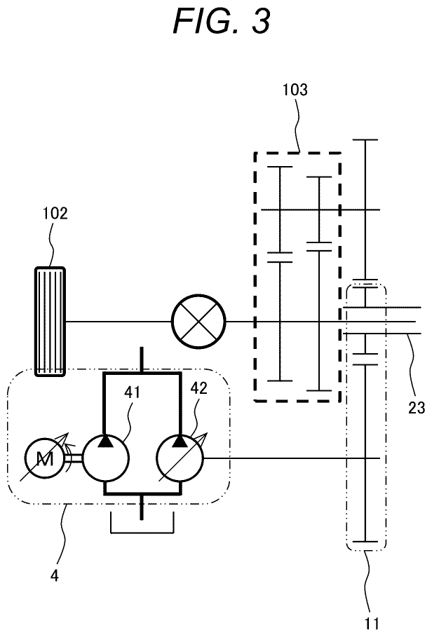

FIG. 3 is a schematic diagram illustrating a changing example (a second changing example: changing example 2) of the driving source of the pump 4 of the cooling system 1 for the rotary electric machine 2 according to the first embodiment of the present invention. When the cooling system 1 is a system combined with a transmission 103, the motive power of the mechanical pump 42 may be secured from the output shaft 23 of the rotary electric machine 2. That is, in this example, the pump 4 includes the mechanical pump 42 and the electric pump 41, and the mechanical pump 42 secures the motive power from the output shaft 23 of the rotary electric machine 2. In this example, a speed reduction gear 11 is disposed between the output shaft 23 and the mechanical pump 42.

In the advantage in this case, the coolant according to the number of rotations of the rotary electric machine 2 can be supplied by securing the motive power from the output shaft 23, and the cooling performance can be maximized. On the other hand, in the disadvantage, since the deviation between the number of rotations of the rotary electric machine 2 and the required number of rotations of the mechanical pump 42 is increased, the speed reduction gear 11 for transmitting the motive power to the mechanical pump 42 becomes larger.

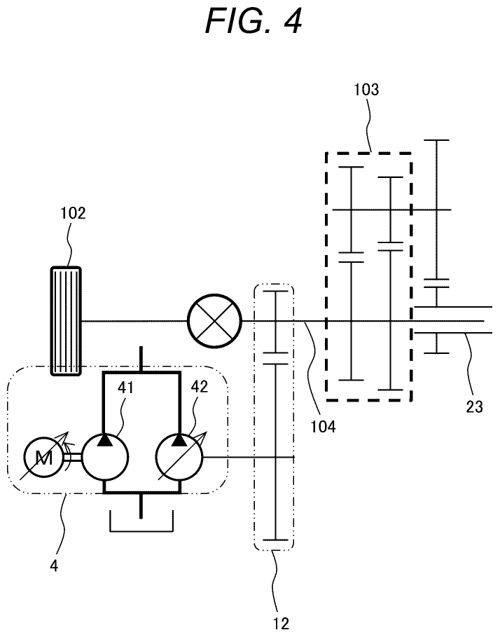

FIG. 4 is a schematic diagram illustrating a changing example (a third changing example: changing example 3) of the driving source of the pump 4 of the cooling system 1 for the rotary electric machine 2 according to the first embodiment of the present invention. When the cooling system 1 is a system combined with the transmission 103, the motive power of the mechanical pump 42 may be secured from the drive shaft 104 driving a tire 102. That is, in this example, the pump 4 includes the mechanical pump 42 and the electric pump 41, and the mechanical pump 42 secures the motive power from the drive shaft 104. In this example, a speed reduction gear 12 is disposed between the drive shaft 104 and the mechanical pump 42.

In the advantage in this case, since the motive power of the mechanical pump 42 is secured from the drive shaft 104, the speed reduction gear 12 for the mechanical pump 42 can be made smaller. On the other hand, in the disadvantage, since the vehicle speed and the number of rotations of the rotary electric machine 2 are different according to the state of the transmission 103, the mechanical pump 42 is made larger in order to be able to secure the cooling performance under the worst conditions.

Returning to FIG. 1, the coolant flow path 7 will be described. The coolant flow path 7 includes a discharge side coolant flow path section 70 connected to the discharge side of the pump 4, the first coolant flow path section 71 supplying the coolant to the stator core 21A, the second coolant flow path section 72 supplying the coolant to the rotor 22, the third coolant flow path section 73 supplying the coolant that has cooled the stator core 21A to the coil end 21B, and the fourth coolant flow path section 74 supplying the coolant that has cooled the stator core 21A to the second coolant flow path section 72.

The first coolant flow path section 71 is a coolant flow path section configured between a branch point P1 as the downstream side end portion of the discharge side coolant flow path section 70 and a first valve 31. The upstream side end portion of the first coolant flow path section 71 is connected to a downstream side end portion P1 of the discharge side coolant flow path section 70, and the first coolant flow path section 71 is configured to communicate with the discharge side coolant flow path section 70. The downstream side end portion of the first coolant flow path section 71 is connected to the first valve 31.

Part 71A of the first coolant flow path section 71 is provided to the surface or in the interior of the stator core 21A, and configures a stator core coolant section 71A. The coolant supplied by the first coolant flow path section 71 cools the stator core 21A, that is, the stator 21, by the stator core cooling section 71A.

The second coolant flow path section 72 is a coolant flow path section configured between a second valve 32 and downstream side end portions P41, P42, P43, and P44 provided to the rotor 22. An upstream side end portion P2 of the second coolant flow path section 72 is connected to the second valve 32. The second valve 32 is provided between the branch point P1 and a branch point P2. The second coolant flow path section 72 is connected through the second valve 32 to the discharge side coolant flow path section 70, and is configured to communicate with the discharge side coolant flow path section 70.

Part 72A of the second coolant flow path section 72 is provided to the output shaft 23 and in the interior of the rotor core 22A of the rotary electric machine 2, and configures a rotor cooling section 72A. The coolant supplied by the second coolant flow path section 72 cools the rotor 22 including the output shaft 23 and the rotor core 22A by the rotor cooling section 72A. The coolant supplied by the second coolant flow path section 72 is supplied to the rotor cooling section 72A to cool the rotor 22, and as indicated by the reference numerals 81, is then dropped to the coil end 21B from the downstream side end portions P41, P42, P43, and P44 of the second coolant flow path section 72. The coolant 81 dropped to the coil end 21B cools the coil end 21B, and is accumulated in the housing 24 of the rotary electric machine 2. The coolant accumulated in the housing 24 is collected from the discharge port 25 through a pipe, not illustrated, into the coolant reserving section 5.

The third coolant flow path section 73 is a coolant flow path section configured between the first valve 31 and downstream side end portions P31 and P32 provided near the stator 21. When the third coolant flow path section 73 is connected through the first valve 31 to the first coolant flow path section 71, the third coolant flow path section 73 leads the coolant supplied from the first coolant flow path section 71 to the downstream side end portions (coolant dropping sections) P31 and P32, and as indicated by the reference numerals 82, drops the coolant from the downstream side end portions P31 and P32 to the coil end 21B. That is, the third coolant flow path section 73 is provided between the first valve 31 and the coolant dropping sections P31 and P32 to the coil end 21B.

The fourth coolant flow path section 74 is a coolant flow path section configured between the first valve 31 and the upstream side end portion (the portion corresponding to the P2) of the second coolant flow path section 72. The upstream side end portion (the portion corresponding to the P2) of the second coolant flow path section 72 configures the branch point of the coolant flow path 7 in which the second coolant flow path section 72 and the fourth coolant flow path section 74 are connected. The downstream side end portion of the fourth coolant flow path section 74 is connected to the upstream side end portion of the second coolant flow path section 72 at the branch point P2. Note that the branch point P2 is not necessarily required to be provided at the upstream side end portion of the second coolant flow path section 72, and is only required to be provided to the portion of the second coolant flow path section 72 on the upstream side with respect to the rotor 22.

The switching mechanism 3 switches the connection states of the first coolant flow path section 71, the second coolant flow path section 72, the third coolant flow path section 73, and the fourth coolant flow path section 74. The switching mechanism 3 of this embodiment is configured of two valves including the first valve 31 and the second valve 32. In this case, the first valve 31 is configured of a 3-port valve, and the second valve 32 is configured of an opening and closing valve. The first valve 31 and the second valve 32 of the switching mechanism 3 are opening and closing controlled by the electronic control unit 6 according to the vehicle speed or the number of rotations (rotation speed) of the rotary electric machine 2.

To control the first valve 31, the electronic control unit (ECU) 6 is connected with the first valve 31 by a signal line E31. To control the second valve 32, the electronic control unit (ECU) 6 is connected with the second valve 32 by a signal line E32.

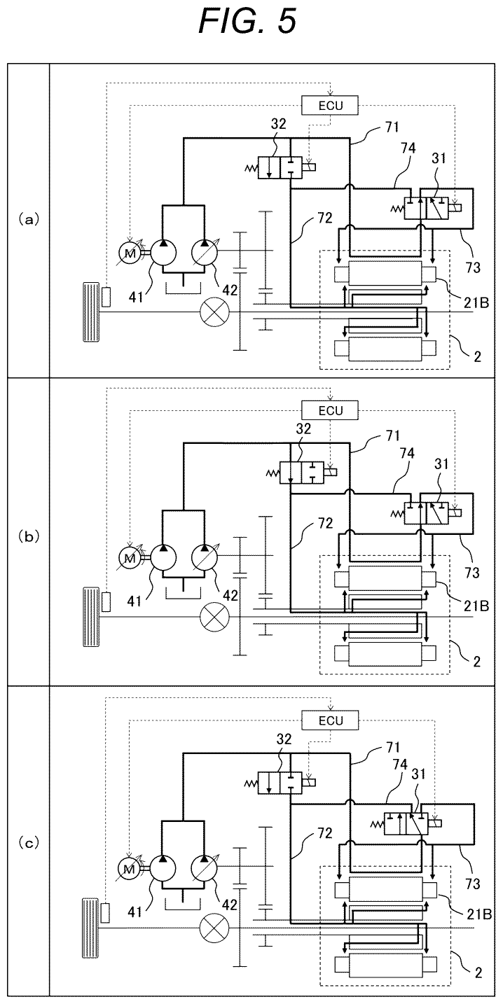

FIGS. 5 are each an explanatory view illustrating the connection mode of the coolant flow path 7 of the cooling system 1 for the rotary electric machine 2 of FIG. 1. Note that FIG. 5(a) illustrates the connection mode of the coolant flow path 7 in the low speed range, FIG. 5(b) illustrates the connection mode of the coolant flow path 7 in the middle speed range, and FIG. 5(c) illustrates the connection mode of the coolant flow path 7 in the high speed range.

The low speed range, the middle speed range, and the high speed range will be defined as follows. The low speed range is a range in which the cooling of the rotary electric machine 2 is established without cooling the rotor 22. The middle speed range is a range between the low speed range and the high speed range. The high speed range is a range in which the total of the required coolant amount of the stator 21 and the required coolant amount of the rotor 22 is equal to or more than the coolant discharge ability limit (the upper limit of the discharge amount of the pump) from the housing 2.

In the low speed range of FIG. 5(a), the switching mechanism 3 achieves a first mode in which the coolant is supplied to the first coolant flow path section 71 and the coolant is not supplied to the second coolant flow path section 72. In this case, the first valve 31 is driven such that the first coolant flow path section 71 and the third coolant flow path section 73 are made to communicate with each other, and the second valve 32 is closed. By closing the second valve 32, the coolant discharge flow path section 70 and the second coolant flow path section 72 are shut off.

In the low speed range of FIG. 5(a), the coolant cools the stator 21 by the stator core cooling section 71A of the first coolant flow path section 71, and is then supplied through the first valve 31 to the third coolant flow path section 73, thereby being dropped to the coil end 21B from the downstream side end portions P31 and P32 (see FIG. 1) of the third coolant flow path section 73. The coolant 82 (see FIG. 1) dropped to the coil end 21B is accumulated in the housing 24 of the rotary electric machine 2, and is collected from the discharge port 25 through the pipe, not illustrated, into the coolant reserving section 5.

In the high speed range of FIG. 5(c), the switching mechanism 3 achieves a second mode in which the downstream side end portion of the first coolant flow path section 71 and the portion of the second coolant flow path section 72 on the upstream side with respect to the rotor 22 are made to communicate with each other. In this case, the first valve 31 is driven such that the first coolant flow path section 71 and the third coolant flow path section 73 are made to communicate with each other, and the second valve 32 is closed. By closing the second valve 32, the coolant discharge flow path section 70 and the second coolant flow path section 72 are shut off.

In the high speed range of FIG. 5(c), the coolant cools the stator 21 by the stator core cooling section 71A of the first coolant flow path section 71, and is then supplied through the first valve 31 to the second coolant flow path section 72 without being supplied to the third coolant flow path section 73. The coolant supplied from the first coolant flow path section 71 to the second coolant flow path section 72 cools the rotor 72 including the output shaft 23 by the rotor cooling section 72A. Thereafter, the coolant is dropped from the downstream side end portions P41, P42, P43, and P44 (see FIG. 1) for the second coolant flow path section 72 to the coil end 21B. The coolant 81 (see FIG. 1) dropped to the coil end 21B cools the coil end 21B, and is accumulated in the housing 24 of the rotary electric machine 2. The coolant accumulated in the housing 24 is collected from the discharge port 25 through a pipe, not illustrated, into the coolant reserving section 5.

In the middle speed range of FIG. 5(b) as the middle range between the low speed range of FIG. 5(a) and the high speed range of FIG. 5(c), the switching mechanism 3 achieves a third mode in which the coolant is supplied to each of the first coolant flow path section 71 and the second coolant flow path section 72. In this case, the first valve 31 is driven such that the first coolant flow path section 71 and the third coolant flow path section 73 are made to communicate with each other, and the second valve 32 is opened to be driven such that the coolant discharge flow path section 70 and the second coolant flow path section 72 are made to communicate with each other.

In the middle speed range of FIG. 5(b), the coolant is supplied from the coolant discharge flow path section 70 to each of the first coolant flow path section 71 and the second coolant flow path section 72. That is, the coolant supplied from the coolant discharge flow path section 70 dividedly flows from the branch point P1 to the first coolant flow path section 71 and the second coolant flow path section 72.

The coolant supplied to the first coolant flow path section 71 cools the stator 21 by the stator core cooling section 71A, and is then supplied through the first valve 31 to the third coolant flow path section 73, thereby being dropped from the third coolant flow path section 73 to the coil end 21B. The coolant dropped to the coil end 21B is accumulated in the housing 24 of the rotary electric machine 2, and is collected from the discharge port 25 through the pipe into the coolant reserving section 5. This is the same as the description in the low speed range of FIG. 5(a).

The coolant supplied to the second coolant flow path section 72 cools the rotor 72 including the output shaft 23 by the rotor cooling section 72A, and is then dropped to the coil end 21B. The coolant 81 (see FIG. 1) dropped to the coil end 21B cools the coil end 21B, and is accumulated in the housing 24 of the rotary electric machine 2. The coolant accumulated in the housing 24 is collected from the discharge port 25 through the pipe into the coolant reserving section 5. This is the same as the description in the high speed range of FIG. 5(c).

In the coil end 21B having a complicated configuration, the coolant having a lower viscosity extends to the details of the coil end 21B, and the thermal conductivity from the coil end 21B to the coolant is increased. In the connection mode of FIG. 5(c), since the coolant heated by the stator core 21A is dropped or sprayed to the coil end 21B, the viscosity of the coolant dropped or sprayed to the coil end 21B is lowered. Thus, the connection mode of FIG. 5(c) is also used for other speed ranges without being limited to the high speed range, so that the thermal conductivity from the coil end 21B to the coolant can be increased to improve the cooling performance of the rotary electric machine 2.

Next, the combination of normally open and normally closed of the first valve 31 and the second valve 32 used for the switching mechanism 3 will be described.

The rotary electric machine 2 is required to be thermally protected at the time of failure in the control of the first valve 31 and the second valve 32. Thus, the combination of normally open and normally closed of the first valve 31 and the second valve 32 is selected to be able to secure the cooling performance of the rotary electric machine 2.

The connection mode of FIG. 5(b) is ideal since the first coolant flow path section 71 which supplies the coolant to the stator 21 and the second coolant flow path section 72 which supplies the coolant to the rotor 22 are connected in parallel, and the coolant can be reliably supplied to the heat generation section. Thus, both of the first valve 31 and the second valve 32 are preferably normally open valves. Note that FIG. 1 illustrates the state where the normally open valves are used as the first valve 31 and the second valve 32 and the power supply is not turned on, and illustrates the state where the first valve 31 and the second valve 32 are opened.

The cooling system 1 for the rotary electric machine 2 of this embodiment is the cooling system 1 for the rotary electric machine 2 including the stator 21 and the rotor 22. The cooling system 1 includes the coolant flow path 7 supplying the coolant, the switching mechanism 3 switching the mode of the coolant flow path 7, and the pump 4 pumping the coolant to the coolant flow path 7. The coolant flow path 7 has the first coolant flow path section 71 supplying the coolant to the core 21A of the stator 21, and the second coolant flow path section 72 supplying the coolant to the rotor 22. The switching mechanism 3 is configured to achieve the first mode (FIG. 5(a)) in which the coolant is supplied to the first coolant flow path section 71 and the coolant is not supplied to the second coolant flow path section 72 and the second mode (FIG. 5(c)) in which the downstream of the first coolant flow path section 71 and the upstream of the second coolant flow path section 72 are made to communicate with each other.

In this case, in the second mode (FIG. 5(c)), the first coolant flow path section 71 and the second coolant flow path section 72 are connected in series, and the coolant that has cooled the stator 21 is supplied to the rotor 22 to cool the rotor 22.

Further, in the cooling system 1 for the rotary electric machine 2 of this embodiment, the switching mechanism 3 is configured to achieve the third mode (FIG. 5(b)) in which the coolant is supplied to each of the first coolant flow path section 71 and the second coolant flow path section 72.

In this case, in the third mode (FIG. 5(b)), the first coolant flow path section 71 and the second coolant flow path section 72 are connected in parallel with respect to the rotary electric machine 2, and the coolant cooling the rotor 22 is supplied to the rotor 22 without passing through the flow path to which the coolant cooling the stator 21 is supplied.

In addition, in the cooling system 1 for the rotary electric machine 2 of this embodiment, in the low speed range, the high speed range as a speed range higher than the low speed range, and the middle speed range between the low speed range and the high speed range, which are included in the rotary electric machine 2, the first mode (FIG. 5(a)) is configured in the low speed range, the second mode (FIG. 5(c)) is configured in the high speed range, and the third mode (FIG. 5(b)) is configured in the middle speed range.

In addition, in the cooling system 1 for the rotary electric machine 2 of this embodiment, the coolant flow path 7 includes the third coolant flow path section 73 in which the coolant is supplied to the coil end 21B of the stator 21, and the fourth coolant flow path section 74 provided such that the downstream side end portion of the fourth coolant flow path section 74 communicates with the second coolant flow path section 72. The switching mechanism 3 includes the first valve 31 and the second valve 32. The first valve 31 is configured to be able to switch the connection mode in which the first coolant flow path section 71 is connected to the third coolant flow path section 73 to communicate with the third coolant flow path section 73 and the connection mode in which the first coolant flow path section 71 is connected to the fourth coolant flow path section 74 to communicate with the fourth coolant flow path section 74. The second valve 32 is disposed between the second coolant flow path section 72 and the pump 4, and is configured to be able to switch the connection mode in which the second coolant flow path section 72 is connected to the coolant discharge flow path 70 for the pump 4 to communicate with the coolant discharge flow path 70 for the pump 4 not through the first coolant flow path section 71, and the connection mode in which the above connection in the connection mode is shut off.

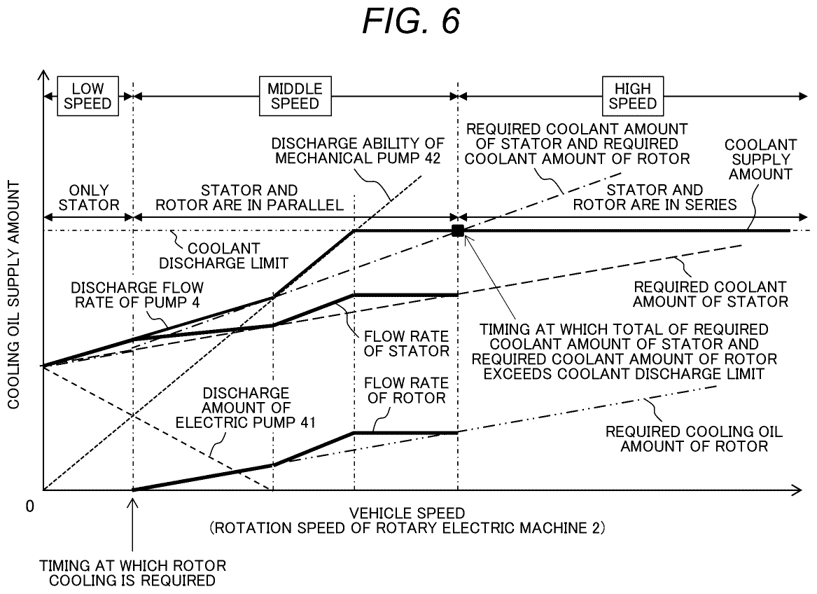

FIG. 6 is a diagram illustrating the relationship between the vehicle speed and the coolant supply amount in the cooling system 1 for the rotary electric machine 2 according to the present invention.

The electric pump 41 is operated to the speed at which the total of the coolant discharge amount of the electric pump 41 and the coolant discharge amount of the mechanical pump 42 exceeds the required coolant amount of the stator 21 and the required coolant amount of the rotor 22. That is, the discharge amount of the electric pump 41 is controlled such that the total of the discharge amount of the electric pump 41 and the discharge amount of the mechanical pump 42 becomes the minimum required coolant amount (the required coolant amount of the stator and the required coolant amount of the rotor). In the low speed range, the direct current loss is dominant, and most of losses are caused in the stator 21. By supplying the coolant only to the stator 21 in the low speed range, even a small pump can secure the coolant amount required in the cooling.

In the middle speed range, the coolant flow paths (the first coolant flow path section 71 and the second coolant flow path section 72) are caused to be in parallel to improve the electric efficiency. To minimize the torque loss of the mechanical pump 42 in the middle speed range having the highest traveling frequency, the switching mechanism 3 is opened and closed in the middle speed range such that the coolant flow paths (the first coolant flow path section 71 and the second coolant flow path section 72) of the stator 21 and the rotor 22 are in parallel. Since the pressure loss is reduced by causing the coolant flow paths to be in parallel, the loss of the mechanical pump 42 can be reduced.

In the high speed range, the electric efficiency is improved by the hydraulic control of the variable displacement mechanical pump 42. In the high speed range, the discharge amount of the mechanical pump 42 exceeds the coolant discharge ability (the coolant discharge limit) of the housing 24, and friction is caused due to the entering of the coolant into the gap of the rotary electric machine 2. Accordingly, in the high speed range, the discharge amount of the variable displacement mechanical pump 42 is limited not to exceed the coolant discharge ability of the housing 24. At this time, when the discharge amount of the variable displacement mechanical pump 42 (≈the coolant discharge ability of the housing 24) is below the required coolant amount of the stator 21 and the required coolant amount of the rotor 22, the switching mechanism 3 is opened and closed such that the coolant paths (the first coolant flow path section 71 and the second coolant flow path section 72) of the stator 21 and the rotor 22 are in series, so that the cooling at the discharge amount of the variable displacement mechanical pump 42 (≈the coolant discharge ability of the housing 24) is established. That is, by causing the coolant paths (the first coolant flow path section 71 and the second coolant flow path section 72) of the stator 21 and the rotor 22 to be in series in the high speed range, the coolant amount required in the cooling can be reduced as compared with the case where the coolant paths (the first coolant flow path section 71 and the second coolant flow path section 72) of the stator 21 and the rotor 22 are in parallel, so that the cooling performance can be achieved within the coolant discharge ability.

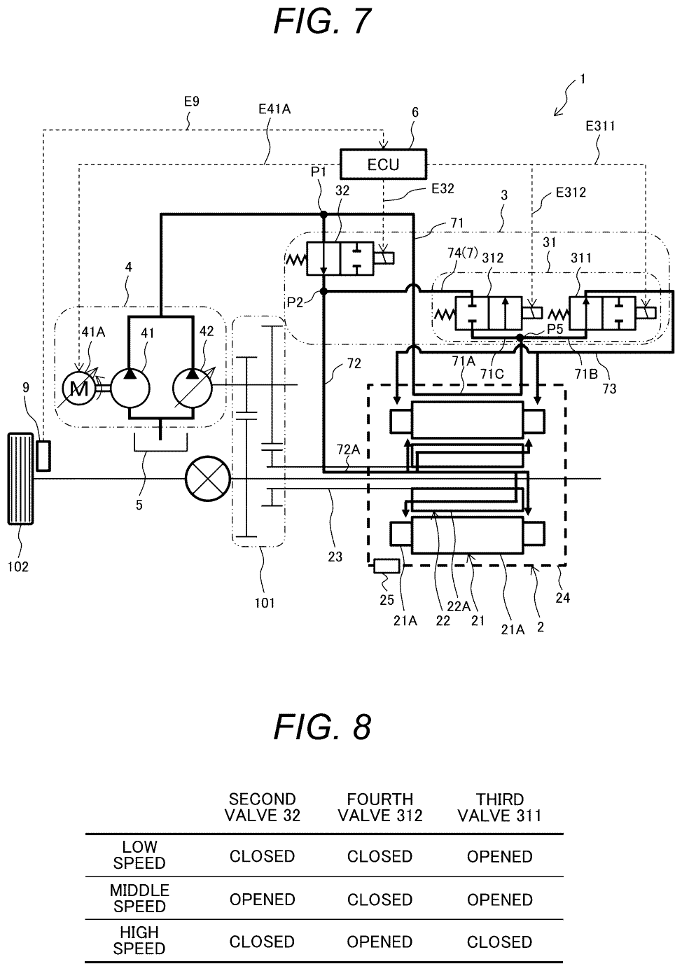

FIG. 7 is a schematic configuration diagram illustrating a changing example (a fourth changing example: changing example 4) of the switching mechanism 3 of the cooling system 1 for the rotary electric machine 2 according to the first embodiment of the present invention.

The switching mechanism 3 is not limited to the configuration by the first valve 31 and the first valve 32 of the first embodiment. For example, the first valve 31 exemplified in the first embodiment can be configured to be divided into two valves 311 and 312, and the switching mechanism 3 of this example is configured of three valves. That is, the first valve 31 of this example is configured of the third valve 311 and the fourth valve 312. The third valve 321 and the fourth valve 322 can be configured of opening and closing valves.

In this example, the downstream portion of the first coolant flow path section 71 is caused to branch into two branch flow path sections 71A and 71B at a branch point P5. The first branch flow path section 71A is connected to the third valve 311 so as to communicate with the third coolant flow path section 73 through the third valve 311. The second branch flow path section 71B is connected to the fourth valve 312 so as to communicate with the fourth coolant flow path section 74 through the fourth valve 312.

That is, in the cooling system 1 for the rotary electric machine 2 of this example, the first valve 31 is configured of the two valves of the third valve 311 and the fourth valve 312. The downstream portion of the first coolant flow path section 71 branches into the first branch flow path section 71B connected to the third valve 311 and a second branch flow path section 71C connected to the fourth valve. The third valve 311 is configured to open and close the connection of the first branch flow path section 71B and the third coolant flow path section 73. The fourth valve 312 is configured to open and close the connection of the second branch flow path section 71C and the second coolant flow path section 72.

As illustrated in FIG. 7, to control the second valve 32, the electronic control unit (ECU) 6 is connected with the second valve 32 by the signal line E32. To control the third valve 311, the electronic control unit (ECU) 6 is connected with the third valve 311 by a signal line E311. To control the fourth valve 312, the electronic control unit (ECU) 6 is connected with the fourth valve 312 by a signal line E312.

In the case of this example, to thermally protect the rotary electric machine 2 at the time of failure in the control of the third valve 311, the fourth valve 312, and the second valve 32, it is preferable that the third valve 311 and the second valve 32 be normally opened and the fourth valve 312 be normally closed. Note that FIG. 7 illustrates the state where the normally open valves are used as the third valve 311 and the second valve 32, the normally closed valve is used as the fourth valve 312, and the power supply is not turned on, and the state where the first valve 31 and the second valve 32 are opened and the fourth valve 312 is closed.

All the same valves may be adopted from the viewpoint of cost. In this case, the magnitude relationship between the respective flow path pressure losses in the normal state should be determined to be able to secure the cooling performance at the time of failure in the valve control. In the case of FIG. 7, for example, all of the third valve 311, the fourth valve 312, and the second valve 32 should be normally opened, and the pressure loss design should be performed such that the coolant flows into the particular coolant path when all of the valves 311, 312, and 32 are opened.

FIG. 8 is a diagram illustrating the opened or closed state of the valve in each speed range of the cooling system for the rotary electric machine of FIG. 7.

As illustrated in FIG. 8, the second valve 32, the third valve 321, and the fourth valve 322 are controlled by a control signal from the electronic control unit 6 according to the traveling mode (vehicle speed range), and the connection mode of the coolant flow path 7 is switched.

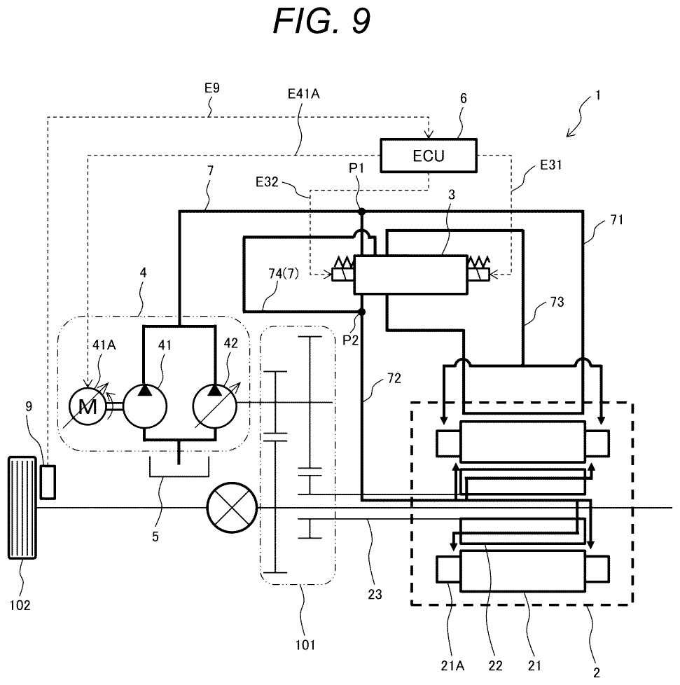

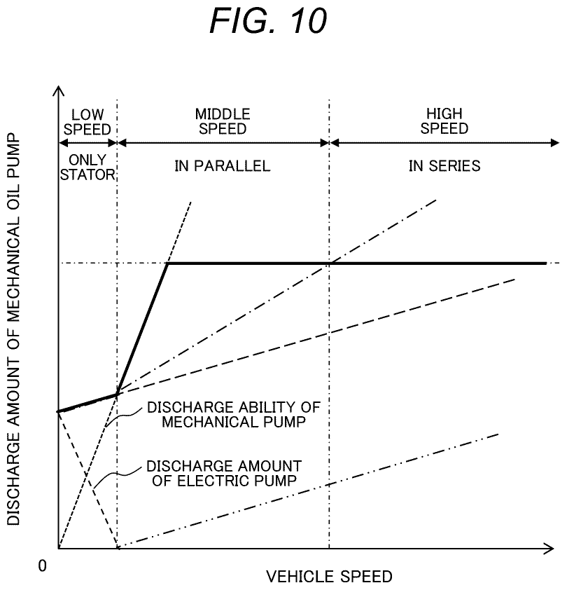

FIG. 9 is a schematic configuration diagram illustrating a changing example (a fifth changing example: changing example 5) of the switching mechanism 3 of the cooling system 1 for the rotary electric machine 2 according to the first embodiment of the present invention.

In the switching mechanism 3 of FIG. 7, some or all of a plurality of valves 32, 311, and 312 may be configured as an integrated unit. For example, the switching mechanism 3 of FIG. 1 is an example in which the third valve 311 and the fourth valve 312 in the switching mechanism 3 of FIG. 7 are configured as an integrated unit (the first valve 31).

In FIG. 9, all the valves 32, 311, and 312 of FIG. 7 are configured as an integrated unit (the valve 3). By integrating the plurality of valves to make an integrated unit, the number of parts can be reduced, and the assembling of the cooling system 1 becomes easy.

FIG. 10 is a diagram illustrating the relationship between the vehicle speed and the coolant supply amount for the case where the operation range of the electric pump 41 is changed in the cooling system 1 for the rotary electric machine 2 according to the present invention.

When the mechanical pump 42 has the remaining discharge ability, as illustrated in FIG. 10, the operation range of the electric pump 41 should be reduced to improve the electric efficiency. In this example, the operation range of the electric pump 41 is limited to the range in which only the stator 21 in the low speed range is cooled.

The present invention is not limited to the above-described embodiments, and further includes various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

1: cooling system for rotary electric machine 2, 2: rotary electric machine, 3: switching mechanism, 4: pump, 7: coolant flow path, 21: stator, 21A: core of stator 21 (stator core), 21B: coil end of stator 21, 22: rotor, 23: output shaft of rotary electric machine 2, 31: first valve, 32: second valve, 41: electric pump, 42: mechanical pump, 70: coolant discharge flow path for pump 4, 71: first coolant flow path section, 71B: first branch flow path section of first coolant flow path section 71, 71C: second branch flow path section of first coolant flow path section 71, 72: second coolant flow path section, 73: third coolant flow path section, 74: fourth coolant flow path section, 101: speed reduction gear, 104: drive shaft, 311: third valve, 312: fourth valve

1. A cooling system for a rotary electric machine including a stator and a rotor,
the cooling system comprising: a coolant flow path supplying a coolant; a switching mechanism switching the mode of the coolant flow path; and a pump pumping the coolant to the coolant flow path, wherein
the coolant flow path has a first coolant flow path section supplying the coolant to a core of the stator, and a second coolant flow path section supplying the coolant to the rotor, and
the switching mechanism is configured to achieve a first mode in which the coolant is supplied to the first coolant flow path section and the coolant is not supplied to the second coolant flow path section, and a second mode in which the downstream of the first coolant flow path section and the upstream of the second coolant flow path section are made to communicate with each other.

2. The cooling system for the rotary electric machine according to claim 1, wherein
in the second mode, the first coolant flow path section and the second coolant flow path section are connected in series, and the coolant that has cooled the stator is supplied to the rotor to cool the rotor.

3. The cooling system for the rotary electric machine according to claim 2, wherein
the switching mechanism is configured to achieve a third mode in which the coolant is supplied to each of the first coolant flow path section and the second coolant flow path section.

4. The cooling system for the rotary electric machine according to claim 3, wherein
in the third mode, the first coolant flow path section and the second coolant flow path section are connected in parallel with respect to the rotary electric machine, and the coolant cooling the rotor is supplied to the rotor through the flow path different from the flow path through which the coolant cooling the stator passes.

5. The cooling system for the rotary electric machine according to claim 4, wherein
in the low speed range, the high speed range as a speed range higher than the low speed range, and the middle speed range between the low speed range and the high speed range, of the rotary electric machine, the first mode is configured in the low speed range, the second mode is configured in the high speed range, and the third mode is configured in the middle speed range.

6. The cooling system for the rotary electric machine according to claim 5, wherein
the coolant flow path includes: a third coolant flow path section in which the coolant is supplied to a coil end of the stator; and a fourth coolant flow path section provided such that the downstream side end portion of the fourth coolant flow path section communicates with the second coolant flow path section,
the switching mechanism includes a first valve and a second valve,
the first valve is configured to be able to switch a connection mode in which the first coolant flow path section is connected to the third coolant flow path section so as to communicate with the third coolant flow path section, and a connection mode in which the first coolant flow path section is connected to the fourth coolant flow path section so as to communicate with the fourth coolant flow path section, and
the second valve is disposed between the second coolant flow path section and the pump, and is configured to be able to switch a connection mode in which the second coolant flow path section is connected to a coolant discharge flow path for the pump so as to communicate with the coolant discharge flow path for the pump not through the first coolant flow path section, and a connection mode in which the above connection in the connection mode where the second coolant flow path section is connected to a coolant discharge flow path for the pump so as to communicate not through the first coolant flow path section is shut off.

7. The cooling system for the rotary electric machine according to claim 6, wherein
the first valve is configured of two valves of a third valve and a fourth valve,
the downstream portion of the first coolant flow path section branches into a first branch flow path section connected to the third valve and a second branch flow path section connected to the fourth valve,
the third valve is configured to open and close the connection of the first branch flow path section and the third coolant flow path section, and
the fourth valve is configured to open and close the connection of the second branch flow path section and the second coolant flow path section.

8. The cooling system for the rotary electric machine according to claim 7, wherein
the pump includes a mechanical pump and an electric pump, and
the mechanical pump secures a motive power from the shaft of a speed reduction gear provided between the rotary electric machine and a drive shaft.

9. The cooling system for the rotary electric machine according to claim 7, wherein
the pump includes the mechanical pump and the electric pump, and
the mechanical pump secures a motive power from an output shaft of the rotary electric machine.

10. The cooling system for the rotary electric machine according to claim 7, wherein
the pump includes the mechanical pump and the electric pump, and
the mechanical pump secures a motive power from the drive shaft.
